(19) United States
(12) Patent Application Publication
(10) Pub. No.: US 2010/0317404 A1
(43) Pub. Date: Dec. 16, 2010

(54) HIGHLY VERSATILE MACHINE-TO-MACHINE CONNECTIVITY MODULE

(75) Inventors: Yossi Moscovitz, Sgonico (IT); Bruno Vittori, Sgonico (IT)

Correspondence Address: SCULLY SCOTT MURPHY & PRESSER, PC, 400 GARDEN CITY PLAZA, SUITE 300, GARDEN CITY, NY, 11530, US

(73) Assignee: TELIT COMMUNICATIONS S.P.A., Sgonico (IT)

(21) Appl. No.: 12/867,550

(22) PCT Filed: Jan. 20, 2009
(86) PCT No.: PCT/EP09/50603

§ 371 Date: Aug. 13, 2010

(30) Foreign Application Priority Data
Feb. 14, 2008 (IT) TS2008A000003

(51) Int. Cl. H04B 1/38

(52) U.S. Cl. 455/558

(57) ABSTRACT

A machine-to-machine connectivity module comprising a first printed circuit that comprises the electronic components for providing a communications module and an element for accommodating a SIM card, the accommodation element being superimposed on the first printed circuit.

### TECHNICAL FIELD

The present invention relates to a highly versatile machine-to-machine connectivity module. More particularly, the invention relates to a so-called machine-to-machine connectivity module with an integrated SIM card and/or service management card reader.

### BACKGROUND ART

As is known, so-called machine-to-machine (M2M) connections are provided by means of particularly small devices that require extreme integrations, capable of meeting the need to minimize the dimensions of the components that are used, in order to facilitate the insertion of such devices within the applications in which they are integrated.

The devices cited above are substantially radio communication modules that allow to provide remote wireless connectivity between devices/machines in a manner that is similar to what occurs among ordinary cellular telephones.

In order to minimize the dimensions of the components used, the communication devices cited above are evolving toward devices that are increasingly small. However, since they must rely on cellular communication networks, such as for example the GSM, GPRS, EDGE, UMTS, CDMA, W-CDMA and others, such devices require the use of a SIM card, which has standard, fixed and non-modifiable dimensions.

Moreover, in such systems, in addition to the SIM card, it is sometimes necessary also to provide for the use of additional mass memories, for example of the SD (Secure Digital), microSD, miniSD, xD or MMC (Multimedia Card) type and the like, or any other medium that is similar to the medium of SIMs, in order to extend ordinary communications to the world of services that are specifically dedicated and focused on the use of these additional memory cards.

The possible fields of application of these solutions can be for example, but not only, surveillance systems, personal safety systems, automotive fleet management systems, et cetera.

Currently available technologies allow to reach size limits of approximately 600 mm² for the so-called actual cellular communications engine, to which it is necessary to add another 600 mm² for the device for accommodating the SIM card and/or the auxiliary service management card.

Solutions are known which integrate these two components, i.e., the communications module and the receptacle of the SIM card, on a single product, requiring connectors between the communication module and the application, i.e., the device to which such module is connected.

If it is necessary to minimize the physical space needed for development of the application, i.e., of the device on which the communication module is to be mounted, and simultaneously reduce the costs of the application, it is conceivable to use a surface mount technology of the BGA (Ball Grid Array) type, in order to integrate the communication module directly within the application.

In this manner, the costs related to the connectors are eliminated. However, due to the containment of the physical dimensions, the possibility to utilize the SIM holder in the same physical space is lost.

As regards the connection between the machine-to-machine connectivity module and the application, i.e., the device on which such module is to be installed, currently there are two types of modules:
modules provided with connectors, with or without a SIM holder;
modules with SMD surface mounting, of the BGA type but without the SIM holder.

### DISCLOSURE OF THE INVENTION

The aim of the present invention is to provide a machine-to-machine connectivity module that allows to have a connection of the BGA type or the like between the cellular communication module and the board of the application i.e., the circuit board of the device onto which the connectivity module is to be mounted, and integrates at the same time a SIM card and/or data card, so as to maximize the reduction of utilized space.

Within this aim, an object of the present invention is to provide a machine-to-machine connectivity module that is capable of complying with the characteristics of containment of unwanted radioelectric emissions of the cellular communication module.

Another object of the present invention is to provide a machine-to-machine connectivity module that allows to eliminate the costs related to the connectors between the module and the application board.

Still another object of the present invention is to provide a connectivity module that is highly reliable, relatively simple to provide and at competitive costs.

This aim, as well as these and other objects that will become better apparent hereinafter, are achieved by a machine-to-machine connectivity module, comprising a first printed circuit, which in turn comprises the electronic components for providing a communications module, and means for accommodating a SIM card, the accommodation means being superimposed on said first printed circuit.

This aim and these objects are also achieved by a machine-to-machine connectivity module with BGA connection or the like, characterized in that it comprises a first printed circuit that is provided with a BGA connection or the like, a second printed circuit that is adapted to support means for accommodating a SIM card, a metallic covering element being adapted to mate, by interference or welding, on a metallic perimetric edge arranged between said first printed circuit and said second printed circuit.

### BRIEF DESCRIPTION OF THE DRAWINGS

Further characteristics and advantages of the present invention will become better apparent from the description of preferred but not exclusive embodiments of the connectivity module according to the present invention, illustrated by way of non-limiting example in the accompanying drawings, wherein:

FIG. 1 is a perspective view of the connectivity module according to the present invention, without the covering element, according to a first embodiment thereof;

FIG. 2 is a perspective view of the connectivity module according to the invention, with the covering element applied;

FIG. 3 is a bottom perspective view of the module shown in FIGS. 1 and 2;

FIG. 4 is a perspective view of the connectivity module according to the present invention, according to a second embodiment thereof;

FIG. 5 is a perspective view, from the side for connection to the application, of the connectivity module according to the present invention;

FIG. 6 is an exploded perspective view of the connectivity module according to the present invention, shown in FIGS. 4 and 5;

FIG. 7 is a sectional view of the connectivity module according to the present invention, shown in FIGS. 4-6.

### WAYS OF CARRYING OUT THE INVENTION

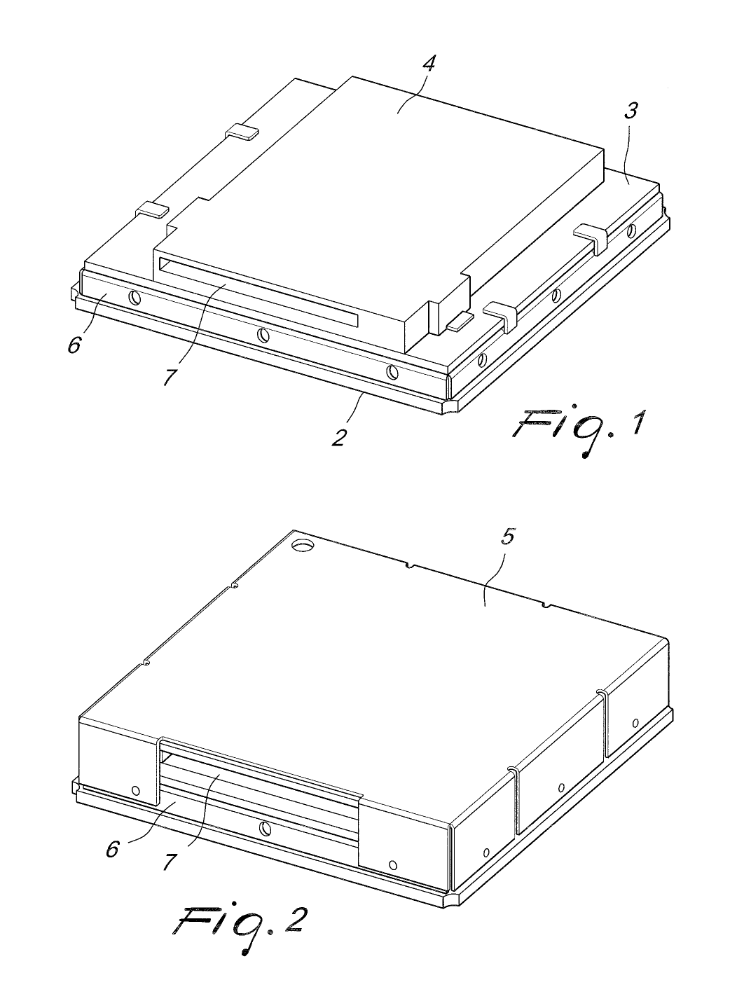

With reference to the figures, the connectivity module according to the present invention, generally designated by the reference numeral 1, comprises, in a first embodiment thereof shown in FIGS. 1-3, a main printed circuit 2, with a BGA connection, on which components are mounted which are necessary to provide the machine-to-machine communications module. The connectivity module further comprises a second printed circuit 3, on which a receptacle 4 adapted to accommodate the SIM card or a similar card is welded. The connections between the main printed circuit 2 and the second printed circuit 3 are provided with an anisotropic conducting elastomer or with a dedicated card-card connector.

The structure thus provided is covered by a metallic screen shield or covering element 5, which is blocked by mechanical interference on a frame 6 which is interposed between the first printed circuit 2 and the second printed circuit 3. In a different embodiment, locking can also occur by welding.

As mentioned, the main printed circuit or first printed circuit 2 can be provided with a BGA connection. However, any other technology of the same type, i.e., that uses matrices of high-density conducting elements that are adapted to be connected to a printed circuit board (PCB), can be adopted equally. The receptacle 4 adapted to accommodate the SIM card is thus provided with a slot 7 that allows to insert the SIM card in the corresponding receptacle 4.

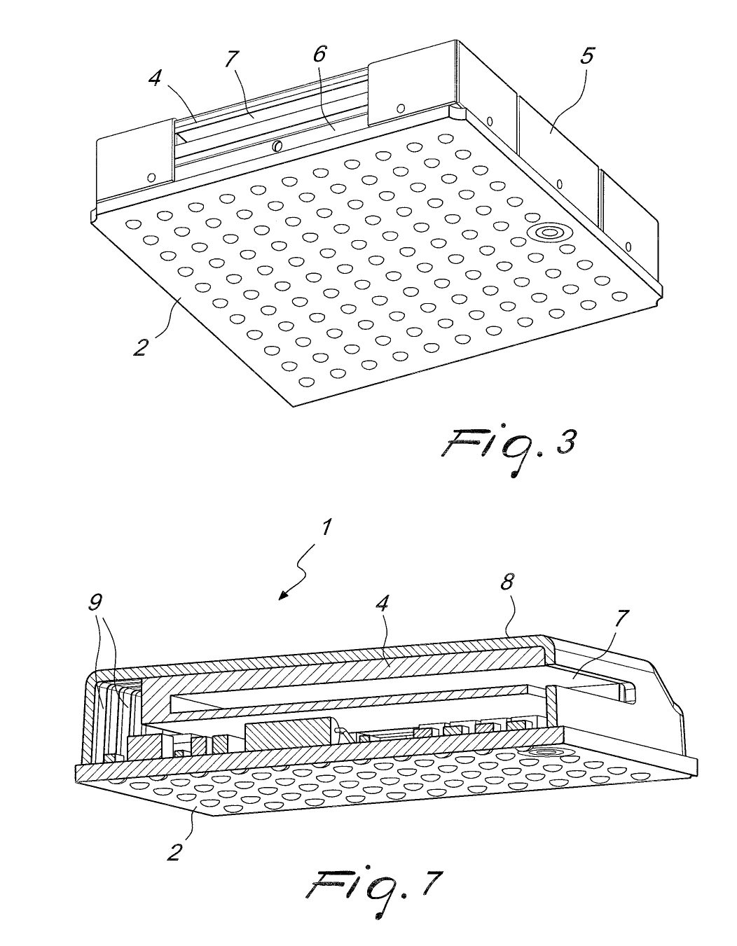

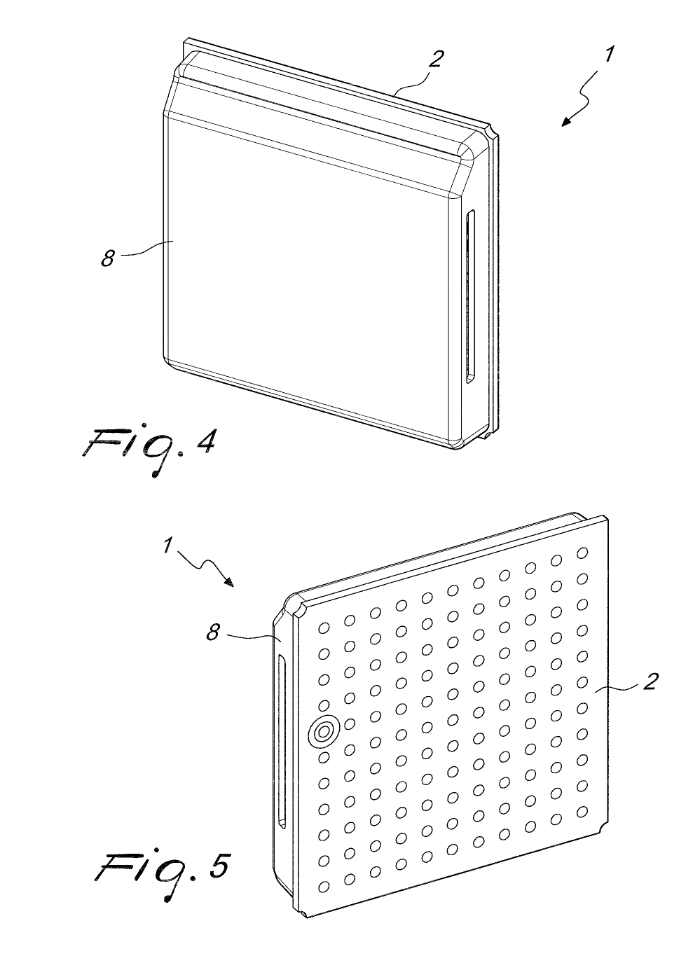

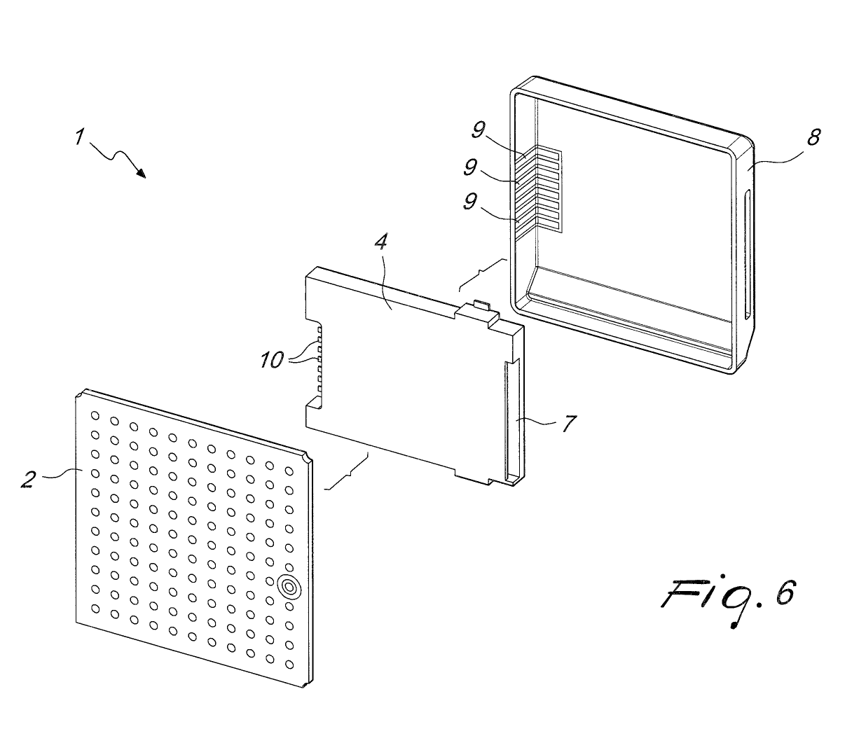

FIGS. 4 to 7 illustrate a second embodiment of the connectivity module according to the present invention, in which the printed circuit 2 or first printed circuit mounts all the components needed to provide the communications module, in a manner similar to the first embodiment described earlier, and a covering element 8 is welded onto this printed circuit 2 and metalized in its inner portion, and the receptacle 4 is welded thereon and allows to accommodate the SIM card in the slot 7.

Conveniently, the covering element 8 made of resin is provided internally with a plurality of metallic contacts 9, which are arranged and contoured so as to affect a portion of its upper surface and thus extend along the edge of the covering made of polymeric resin, for example L-shaped as in FIG. 6.

The connections between the receptacle 4 of the SIM card and the printed circuit 2 are provided by means of the previously described metallic contacts 9.

The metallic contacts 9 in fact make contact with the terminals 10 of the receptacle 4 of the SIM card or the like.

The receptacle 4 is welded or bonded by means of conducting adhesives on the metalization of the metalized covering element.

The metalized covering element is welded, or bonded by means of conducting adhesives, or coupled mechanically and connected electrically by means of conducting gaskets, directly onto the first printed circuit 2.

In a further embodiment, and with reference to what has been described above, accommodation means for a memory card, or directly a memory card (not shown in the figures), is positioned so as to be superimposed on the first printed circuit 2 and on said containment means 4 for a memory card. The accommodation means for a memory card can be arranged below the covering means 5, 8 or above them, providing in both of them electrical terminals for connection in a manner similar to what is shown with reference to the accommodation means 4 of a SIM card.

In practice it has been found that the connectivity module according to the present invention fully achieves the intended aim and objects, since it allows to be provided with extremely compact dimensions, so that it can be integrated easily in devices that require such connectivity module.

The connectivity module thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. TS2008A000003 from which this application claims priority are incorporated herein by reference.

1-10. (canceled)

11. A machine-to-machine connectivity module, comprising a first printed circuit that comprises the electronic components for providing a communications module and means for accommodating a SIM card, wherein said accommodation means are superimposed on said first printed circuit.

12. The machine-to-machine connectivity module according to claim 11, comprising a metallic covering element.

13. The connectivity module according to claim 12, comprising a second printed circuit, which is superimposed on said first printed circuit, and wherein said covering element is adapted to mate on a perimetric edge that is arranged between said first printed circuit and said second printed circuit.

14. The connectivity module according to claim 13, wherein said perimetric edge comprises a metallic frame and said covering element is adapted to mate on said perimetric edge by interference.

15. The connectivity module according to claim 13, wherein the first printed circuit and the second printed circuit are connected with an anisotropic conducting elastomer or by means of a dedicated connector.

16. The connectivity module according to claim 12, wherein said accommodation means are jointly connected to said covering element, said covering element comprising metallic contacts that are defined on the internal surface and are adapted to mate with terminals of said means for accommodating the SIM card.

17. The connectivity module according to claim 16, wherein said accommodation means are welded or bonded by means of conducting adhesives to a metalization of the internal surface of said covering element.

18. The connectivity module according to claim 11, wherein said accommodation means are provided with a slot for the insertion of said SIM card.

19. The connectivity module according to claim 12, wherein said covering element is welded, or bonded by means of conducting adhesives, or coupled mechanically and connected electrically by means of conducting gaskets, directly on the first printed circuit.

20. The connectivity module according to claim 11, further comprising means for accommodating a memory card and wherein said first printed circuit, said means for accommodating a SIM card, and said means for accommodating a memory card are arranged so as to be superimposed one another.
